(19) United States
(12) Patent Application Publication
(10) Pub. No.: US 2015/0338498 A1
(43) Pub. Date: Nov. 26, 2015

(54) CAMERA AND METHOD FOR CAPTURING IMAGE DATA

(71) Applicant: SICK AG, Waldkirch (DE)

(72) Inventors: Helmut WEBER, Waldkirch (DE); Florian SCHNEIDER, Waldkirch (DE)

(21) Appl. No.: 14/679,050

(22) Filed: Apr. 6, 2015

(30) Foreign Application Priority Data
May 26, 2014 (EP) 14169806.8

(51) Int. Cl. G01S 3/786; H04N 5/235

(52) U.S. Cl. CPC G01S 3/7864; H04N 5/2354

(57) ABSTRACT

A camera (10) comprises an image sensor (16) for capturing image data from a detection area (14), an illumination unit (26) with a plurality of light sources (28a-b) for illuminating the detection area (14), first deflection optics (20) having at least two reception light deflection elements (22a-b) to image at least two adjacent partial regions (24a-b) of the detection area (14) onto the image sensor (16) one above the other, and second deflection optics (34) having a plurality of illumination deflection elements (36a) associated with the light sources (28a-b) for shifting illumination fields (32a-b) of the light sources (28a-b) and thus homogenously illuminate the partial regions (24a-b).

The invention relates to a camera comprising an image sensor and a method for capturing image data.

In industrial applications, cameras are used in a variety of ways to automatically detect object properties, for example for the inspection or measurement of objects. Images of the objects are acquired and evaluated according to the task by image processing methods. Another application of cameras is the reading of codes. Such camera-based code readers increasingly replace bar code scanners which are still widespread. By means of an images sensor, objects having the codes thereon are recorded, code regions are identified in the images and are then decoded. Camera-based code readers can easily handle other code types than one-dimensional bar codes, which may also be two-dimensional like a matrix code and provide more information.

A frequent detection situation is to mount the camera above a conveyor belt, where subsequent processing steps are taken depending on the detected object properties. These processing steps may for example be a processing adapted to the specific object with a machine acting on the conveyed objects, or a change of the object flow by removing certain objects from the object flow as part of a quality control or by sorting the object flow into a plurality of partial object flows.

The detection area of a common camera often does not suffice to cover the full desired width in particular of a conveyor belt. As a known solution, a plurality of cameras is mounted side by side. While this solves the problem, it requires considerable extra costs for the plurality of cameras and their mounting and coordination.

DE 20 2013 009 198 U1 therefore proposes a system for a field of view extension of a camera that is based on an attached module with two mirrors. Therefore, an extended field of view is imaged in two strips one above the other. Depending on the focal length, the module can be rather large. In addition, the tilt in two axis results in the images of the two strips having a slight angle to each other. In an embodiment where the illumination also makes use of the mirror, there is a local excess of brightness on the object side in an overlap region of the two strips.

EP 2 624 042 A2 discloses a mirror attachment with a construction of four mirrors for a similar field of view extension. While the tilt of the imaged strips can be avoided by the additional mirrors, the costs for the mirror attachment are increased. Moreover, this solution requires even more space.

EP 1 931 133 A1 uses various embodiments of an optical system to multiply image a structure in mutually separated and displaced regions on an image sensor. One embodiment is based on a double prism, but without explaining its design and application in any detail. An illumination is not provided.

It is known from DE 10 2005 031 710 A1 to illuminate the reading field of a code reading line camera with a linear arrangement of light emitting diodes. In some embodiments, the transmission optics assign a lens having a wedged surface to each light emitting diode. This shifts the individual illumination fields of the light emitting diodes in order to collectively form a homogenous light line. DE 10 2005 031 710 A1 is not at all concerned with a field of view extension, and the line camera would not have any way of imaging strips one over the other.

It is therefore an object of the invention to improve the acquisition of image data in case of a field of view extension.

This object is satisfied by a camera comprising an image sensor for capturing image data from a detection area, an illumination unit with a plurality of light sources for illuminating the detection area, first deflection optics having at least two reception light deflection elements to image at least two adjacent partial regions of the detection area onto the image sensor one above the other; and second deflection optics having a plurality of illumination deflection elements associated with the light sources for shifting illumination fields of the light sources and thus homogenously illuminating the partial regions.

The object is also satisfied by a method for capturing image data from a detection area illuminated by an illumination unit with a plurality of light sources, wherein two adjacent partial regions of the detection area are imaged onto an image sensor one above the other by means of first deflection optics having at least two reception light deflection elements, and wherein illumination fields of the light sources are shifted by means of a plurality of illumination deflection elements associated with the light sources in order to homogeneously illuminate the partial regions.

For a field of view extension of the camera, the first deflection unit for the reception path having at least two reception light deflection elements images two adjacent or side-by-side partial regions of the detection area onto the image sensor one above the other. Then, the invention starts from the basic idea to provide second deflection optics for the transmission path having a plurality of illumination deflection elements which shift the illumination fields of the light sources and thus homogenously illuminate the partial regions.

Here, a deflection unit refers to a refractive optical element based on light refraction and not on reflection like a mirror. Relative geometric relations such as adjacent (side-by-side) or one above the other are exchangeable with rotation of the camera. Further, the number of light sources does not necessarily correspond to the number of illumination deflection elements, for example by one illumination deflection unit being used for two light sources each.

The invention has the advantage that a more compact design is enabled, where the overall size is reduced and at the same time the partial regions are not tilted or at least less tilted against each other as compared to using mirrors. The more homogenous illumination achieved by the illumination deflection elements for example results in lower edge region loss or a shift of the edge region loss to outside the detection area, respectively, as well as in avoiding excess intensity when partial regions overlap.

The reception light deflection elements preferably comprise prisms. Throughout this specification, preferably or preferred refers to a preferred, but completely optional feature. The first deflection optics thus preferably is a double or multiple prism. The individual prisms are preferably identically designed in order to have a symmetrical structure. However, deviations are possible, up to the extreme case where one of the reception deflection elements is a simple plate without optical effect or even completely absent. This may be sufficient to achieve an imaging of partial regions one above the other at a homogenous illumination by the other reception deflection element being designed as a corresponding prism possibly with larger deflection angles.

The prisms preferably comprise slants in longitudinal and transverse direction. Slants refer to slanted surfaces leading to the optical effect of the prism to give a light beam a new direction by refraction. A slanting of this surface in longitudinal direction provides an extension angle extending the field of view. An additional slant in transverse direction shifts the two imaged partial regions to a same height. In this context, it is irrelevant whether the prism actually still is a prism in the geometric sense, and only the optical effect as described is relevant that a light beam is deflected or practically folded in longitudinal and transverse direction so that such a deflection element still is referred to as a prism in this specification.

The prisms preferably comprise slants on the front side and the back side. Thus, deflection does not only take place at one surface, but at the front side and the back side. This allows additional design options for suppressing imaging errors or interfering back reflections.

In another embodiment of the invention, the reception light deflection elements are preferably formed in two parts with a transparent elastic interlayer. The two parts are for example plates or are already prisms themselves. By exerting force onto the transparent elastic interlayer, the effective deflection angle can flexibly be adjusted in this embodiment.

An illumination deflection element is preferably assigned to each light source. In this embodiment, there is a one-to-one correspondence of light sources and illumination deflection elements. This creates a large variety of adaptions for the illumination fields.

The illumination deflection elements preferably comprise prisms. Regarding design options and advantages of these prisms, what has been said about the reception light deflection elements applies correspondingly. It is also conceivable to combine respective transmission optics with prisms by slanting the base surface of a lens.

The illumination deflection elements are preferably arranged around the reception light deflection elements. This arrangement in particular is circular. This arrangement enables an effective illumination of the detection area which becomes even more homogenous by the illumination deflection elements. The arrangement of the light sources preferably is correspondingly around reception optics of the image sensor, and in particular circular.

The first deflection optics and the second deflection optics are preferably formed as a common component. Thus, for example by one-piece manufacturing in particular as an injection molded part, the deflection in the reception path and transmission path is achieved particularly easy, compact, and inexpensive.

The camera preferably is a camera-based code reader or a camera for an inspection or measurement of objects and comprises an evaluation unit for reading codes or determining object properties from the image data. By means of the deflection elements, for example, a wider conveyor belt can be covered and illuminated homogenously.

The inventive method can be modified in a similar manner and shows similar advantages. Such advantageous features are described in the sub claims following the independent claims in an exemplary, but non-limiting manner.

The invention will be explained in the following also with respect to further advantages and features with reference to exemplary embodiments and the enclosed drawing. The Figures of the drawing show in:

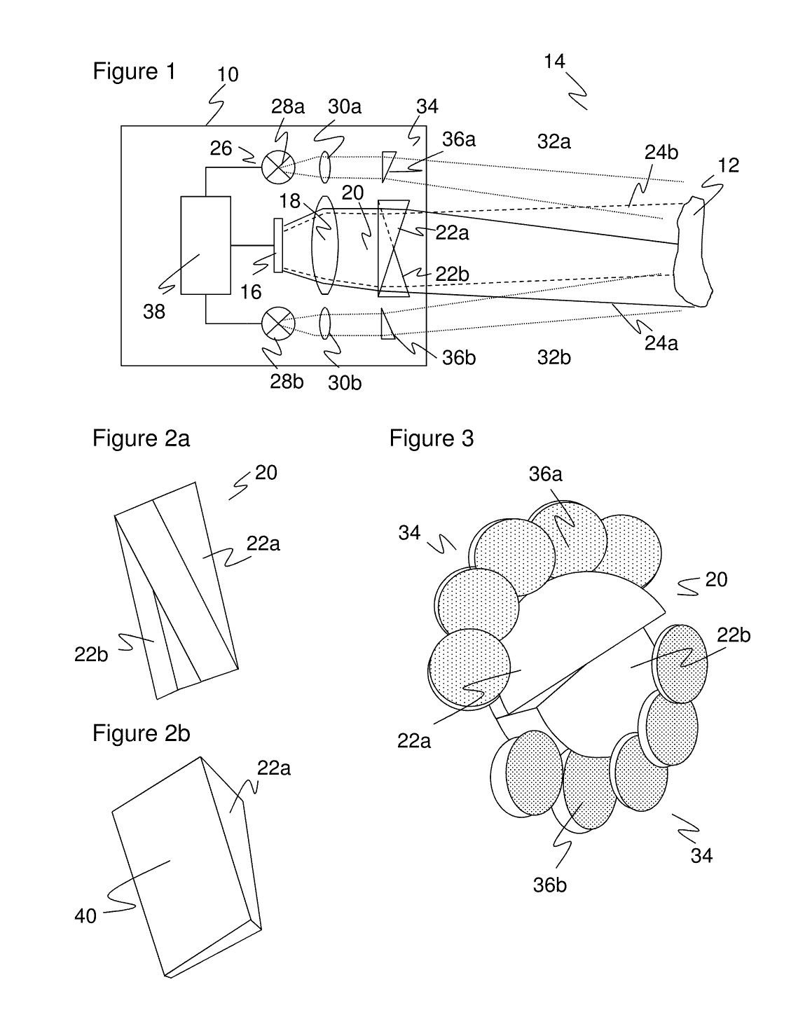

FIG. 1 a schematic of a camera having deflection optics;

FIG. 2a a three-dimensional view of an embodiment of deflection optics being a double prism;

FIG. 2b a three-dimensional view of only one prism of the double prism;

FIG. 3 a three-dimensional view of combined deflection optics for reception path and transmission path;

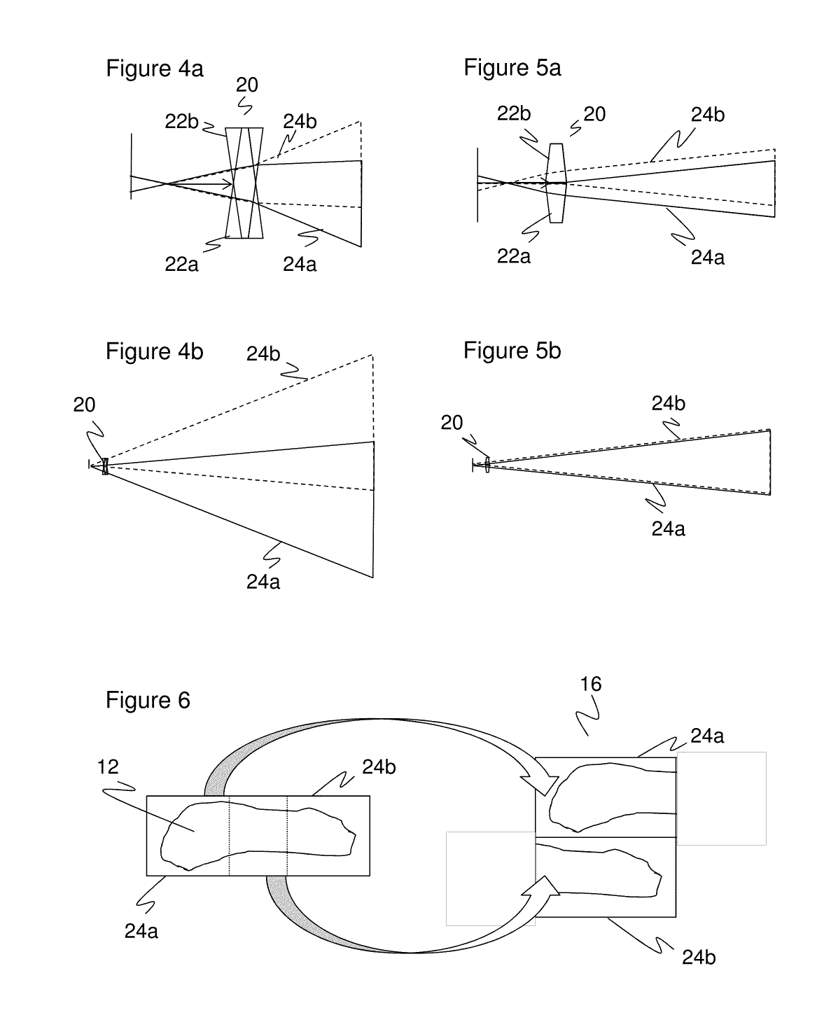

FIG. 4a a representation of the imaging of two partial regions of the detection area with a double prism in a near range detailed view;

FIG. 4b a representation according to FIG. 4a on a different scale;

FIG. 5a a representation according to FIG. 4a after rotation of 90° about the optical axis;

FIG. 5b a representation according to FIG. 5a on a different scale;

FIG. 6 an illustration of the imaging of adjacent partial regions of an object onto an image sensor one above the other;

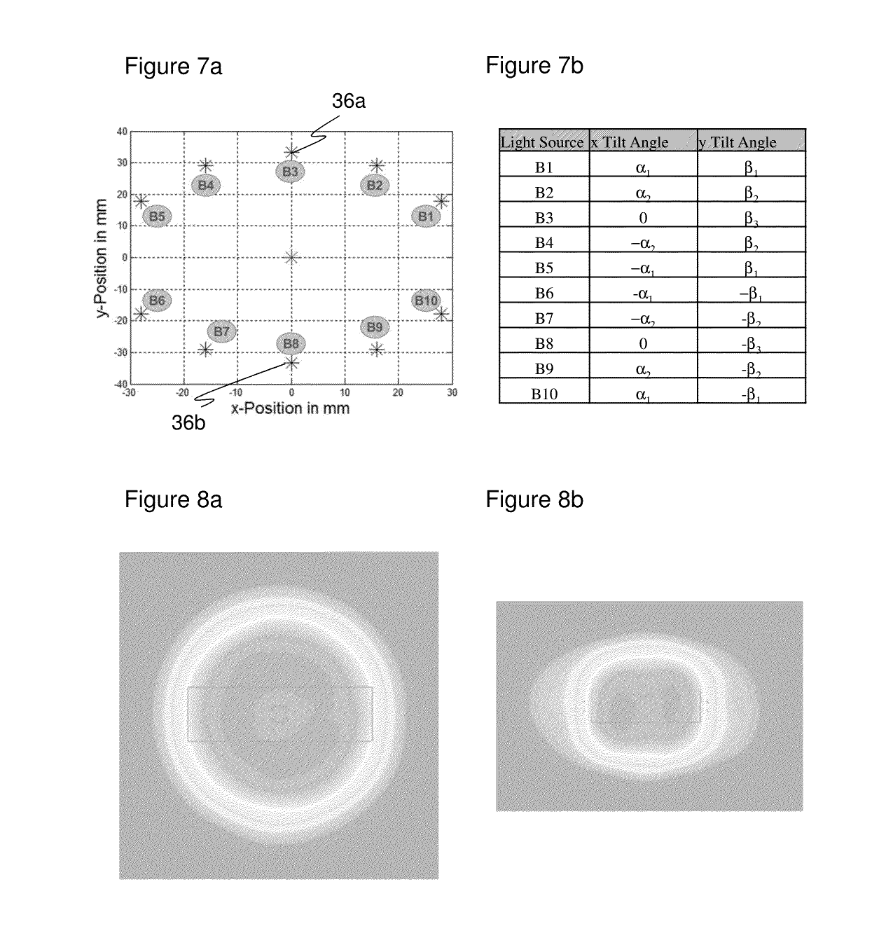

FIG. 7a an exemplary distribution of light sources around the optical axis of reception optics;

FIG. 7b a table of tilt angles of the light sources according to FIG. 7a;

FIG. 8a an intensity distribution of the illumination without transmission side deflection elements for comparison; and

FIG. 8b an intensity distribution of the illumination with suitably adapted transmission side deflection elements.

FIG. 1 shows a schematic of a camera 10 for capturing image data of an object 12 in a detection area 14 by means of an image sensor 16. Reception optics 18, shown as a simple lens representative for an arbitrary objective, are arranged in front of the image sensor 16. Reception side deflection optics 20, for example designed as a double prism having two prisms 22a-b, split the detection area 14 into two partial regions 24a-b which are imaged onto the image sensor 16 one above the other.

An illumination unit 26 generates illumination fields 32a-b with a plurality of light sources 28a-b and transmission optics 30a-b arranged in front of them. Transmission side deflection optics 34 with a plurality of prisms shift the illumination fields 32a-b to achieve, in their superposition, a homogenous illumination for the imaging of the partial regions 24a-b. The elements 28a-b, 30a-b, 36a-b of the illumination unit 26 shown only at both sides in the sectional view of FIG. 1 are distributed in a ring around the optical axis of the reception optics 18 in a preferred embodiment.

An evaluation unit 36 receives the image data of the image sensor 16 and controls the illumination unit 26. Object information is obtained from the image data, which may in dependence on the implementation and application be for inspection with measurement or detection of certain color or shape properties, or in the specific case of a camera-based code reader for the identification of code regions and reading of code information for example of bar codes or two-dimensional code.

FIG. 2a shows the reception side deflection optics 20 in a three-dimensional representation. The embodiment as a double prism and in particular the specific geometry as shown are to be understood as an example. Other deflections based on light refraction are also possible, for example by free-form surfaces, tilted and in particular toric lenses and the like. However, it is important that there is actually a deflection of the beam path, as opposed for example to a simple focusing, because otherwise the partial regions 24a-b cannot be imaged onto the image sensor 16 one above the other. Nevertheless, an additional focusing for example by curvature of some surfaces of the double prism is possible, as well as the additional use of the prism surfaces for correcting imaging errors, if necessary by consecutive arrangement of a plurality of prisms or combination of the prisms with other optical elements. By more than two adjacent prisms 22a-b, additional partial regions 24a-b can be generated and imaged onto the image sensor 16 one above the other in order to additionally expand the detection area 14.

FIG. 2b shows an individual prism 22a of the reception side deflection optics 20. It can easily be seen that there are slants both in the longitudinal and the transverse direction. Therefore, the front surface 40 of the prism 22a is slanted in both directions with respect to the back surface which cannot be seen in FIG. 2b and thus provides a light deflection in two axes. The deflection angles are dependent not only on the prism angles, but also on the refractive index of the prisms 22a-b.

FIG. 3 shows a three-dimensional representation of an embodiment of the deflection optics 20, 34. In this case, the double prism of the reception side deflection optics 20 has an approximately circular outer contour and is annularly surrounded by the transmission side deflection optics 34. The prisms 36a-b of the transmission side deflection optics 34 are divided into two groups which are associated with the two prisms 22a-b of the reception side deflection optics 20. Prisms 36a-b are each associated with a light source 28a-b and are tilted with respect to one another in order to shift the illumination fields 32a-b to obtain a homogenous overall illumination.

The individual prisms 36a-b and 22a-b each may have different tilts and thus may cause different deflection angles. However, it is also conceivable that for example the prisms 36a and 36b, respectively, i.e. the transmission side prisms which are associated with the reception side prisms 22a and 22b, respectively, all have the same tilt. Moreover, several light sources can be associated with one prism 36a or 36b, respectively. In a simple embodiment, the tilts of the transmission side prisms 36a or 36b, respectively, of a partial region can be the same as the tilt of the associated reception side prism 22a or 22b, respectively.

The deflection optics 20, 34 may be made of glass or plastic. The latter allows manufacturing of the deflection optics 20, 34 as a common component in a particularly simple manner in a preferred embodiment, for example in an injection molding or injection compression method. A post processing or finishing of the transmission surfaces for an improved imaging quality is possible.

The imaging by the reception side optics 20 will now be explained in more detail with reference to FIGS. 4 to 6. FIG. 4 illustrates the deflection in longitudinal direction, where the deflection generates an expansion angle which leads to an expansion of the object field or detection area 14. FIG. 4a is a detailed view of the near range, while FIG. 4b shows the optical path in a larger scale. The overlap of the two partial regions 24a-b may be made larger by selection of the prism angles or may conversely be made to completely disappear. A gap between the partial regions 24a-b is also conceivable, for example when the field of view of the camera includes two parallel production lines with an irrelevant intermediate region. Together, the partial regions 24a-b cover a greater width than image sensor 16 and reception optics 18 without the reception side deflection optics 20.

FIG. 5 correspondingly illustrates the deflection in transverse direction, i.e. it is a view which is rotated around the optical axis by 90° with respect to FIG. 4. Again, FIG. 5a is a detailed view of the near range, and FIG. 5b shows the optical path in a larger scale. In this embodiment, the deflection generates a correction angle in the transverse direction which can be used to shift the partial regions 24a-b to a same height. This correction depends on the application and may sometimes not be necessary or even not desirable.

The effect of the reception side deflection optics 20 on the image of the camera 10 is again illustrated by way of example in FIG. 6. On the left, the object domain is shown, i.e. the extended detection area 14 with the object 12, where the two partial regions 24a-b are arranged side by side due to the deflection in longitudinal direction and thus cover a larger width. In lateral direction, the partial regions 24a-b are at a same height due to suitable prism angles in transverse direction.

In the image domain, or on the image sensor 16, respectively, the partial regions 24a-b are imaged one above the other, as shown on the right in FIG. 6. Thus, a conventional image sensor 16 and reception optics 18, respectively, with a more quadratic and usual aspect ratio of for example 4/3 or 16/9 may be used while still achieving a very broad aspect ratio. By downstream image processing, in the evaluation unit 18 or external, it is possible to combine the two partial regions 24a-b side-by-side (image stitching). On the other hand, it is also conceivable to make the overlap regions imaged in both partial regions 24a-b large enough so that a captured object section of a region of interest (ROI) of known size, in particular a code, is always completely detected in at least one partial region 24a-b. Then, a stitching to a uniform image is not necessary for the further evaluation or decoding.

FIGS. 7 and 8 illustrate a possible configuration of the transmission side optics 34. Their task is to provide a homogenously and efficiently illuminated image on the image sensor 16 taking account of the reception side deflection optics 20. To that end, specific deflection angles or tilts of the individual prisms 36a-b are to be selected, which for example avoid an edge light loss or central excess intensity (homogeneity) and at the same time have a favorable relation of illumination intensity inside as compared to outside the detection area (efficiency).

FIG. 7a shows an exemplary distribution symmetric to the optical axis of the camera 10 of ten light sources 28a-b or their associated prisms 34a-b, respectively. In the table according to FIG. 7b, tilt angles are defined in two axes. Due to the symmetry, five parameters α₁-α₂, β₁-β₃ are enough to describe the tilts.

These five parameters may systematically be varied in a simulation, and the respective homogeneity and efficiency is evaluated. This results in optimized tilt angles. FIG. 8 shows an example of an achieved improvement, where FIG. 8a shows the intensity distribution in grayscale without the transmission side deflection optics 34 and FIG. 8b shows an intensity distribution achieved by the transmission side deflection optics 34 with suitable tilt angles. In the optimization, there can be a selection which criterion is more important, for example to obtain particularly little edge loss with a little less efficiency or vice versa.

As pointed out several time, the embodiments as described are exemplary. Some possible variations will be mentioned in the following. FIGS. 4 and 5 show a double prism as the reception side deflection optics 20 where both the entry surface and the exit surface comprise prism angles. It is also possible to arrange one of the surfaces orthogonally, but dividing the deflection into two prism angles allows for a beneficial influence on imaging errors, back reflections and similar interference effects. More prisms or other optical elements can additionally be used.

Instead of fixed prism angles, a transparent elastic material, such as an optical silicone, can be arranged between two plates or prisms. This results in deflection angles which are adjustable in both axes.

As already mentioned, prisms can anywhere be replaced by other light deflecting elements. Moreover, it is possible that a prism 22a-b of the double prism of the reception side deflection optics 20 or one or more prisms 36a-b of the reception side deflection optics 34 are omitted, so that a part of the beam path remains unaffected and only the remaining beam path is deflected, with in principle the same result.

The optical path of the image acquisition is separated from the optical path of the illumination in the embodiments as shown. This can be reinforced by an actual channel separation, such as a tube or the like, in order to suppress stray light or back reflections. Due to the separation, the configuration may also be independent, for example to have a higher optical quality in the reception path than in the transmission path in order to save costs, since sometimes the requirements in the transmission path are lower. In addition, by the separation of imaging and illumination a smaller prism thickness can be used, which simplifies manufacturing and further reduces size. The respective components also do not have to be arranged in a same plane which offers more design options. Additional optical elements beyond the shown elements are possible. This includes a further downstream deflection or correction optics for imaging errors of the prisms 22a-b, 36a-b.

The deflection optics 20, 34 may be designed rotatable to adapt the detection area 14 and the partial regions 24a-b to the application. It is known to use aiming devices which for example mark the detection area 14 by a crosshair. This aiming device may be split onto the two partial regions 24a-b, in particular using prisms 22a-b, 36a-b, for providing alignment assistance for both partial regions 34a-b. Finally, the deflection optics 20, 34 may form a removable attachment for retrofitting a camera 10, or may be integrated into a top or front window of the camera 10.

1. A camera (10) comprising an image sensor (16) for capturing image data from a detection area (14);
an illumination unit (26) with a plurality of light sources (28a-b) for illuminating the detection area (14);
first deflection optics (20) having at least two reception light deflection elements (22a-b) to image at least two adjacent partial regions (24a-b) of the detection area (14) onto the image sensor (16) one above the other; and
second deflection optics (34) having a plurality of illumination deflection elements (36a) associated with the light sources (28a-b) for shifting illumination fields (32a-b) of the light sources (28a-b) and thus homogenously illuminating the partial regions (24a-b).

2. The camera (10) according to claim 1, wherein the reception light deflection elements (22a-b) comprise prisms.

3. The camera (10) according to claim 2, wherein the prisms (22a-b) comprise slants in longitudinal and transverse direction.

4. The camera (10) according to claim 2, wherein the prisms (22a-b) comprise slants on the front side and the back side.

5. The camera (10) according to claim 1, wherein the reception light deflection elements (22a-b) are formed in two parts with a transparent elastic interlayer.

6. The camera (10) according to claim 1, wherein an illumination deflection element (36a-b) is assigned to each light source (28a-b).

7. The camera (10) according to claim 1, wherein the illumination deflection elements (36a) are arranged around the reception light deflection elements (22a-b).

8. The camera (10) according to claim 1, wherein the first deflection optics (20) and the second deflection optics (34) are formed as a common component.

9. The camera (10) according to claim 1, the camera (10) being a camera-based code reader or a camera for an inspection or measurement of objects (12) and comprising an evaluation unit (38) for reading codes or determining object properties from the image data.

10. A method for capturing image data from a detection area (14) illuminated by an illumination unit (26) with a plurality of light sources (28a-b), wherein two adjacent partial regions (24a-b) of the detection area (14) are imaged onto an image sensor (16) one above the other by means of first deflection optics (20) having at least two reception light deflection elements (22a-b), wherein illumination fields (32a-b) of the light sources (28a-b) are shifted by means of a plurality of illumination deflection elements (36a-b) associated with the light sources (28a-b) in order to homogeneously illuminate the partial regions (24a-b).
